(19) United States
(12) Patent Application Publication
(10) Pub. No.: US 2018/0051962 A1
(43) Pub. Date: Feb. 22, 2018

(54) MULTI-FUNCTIONAL SELF-DEFENSE DEVICE

(71) Applicant: YING-CHUN WONG, Taipei City (TW)

(72) Inventor: YING-CHUN WONG, Taipei City (TW)

(21) Appl. No.: 15/238,474

(22) Filed: Aug. 16, 2016

(51) Int. Cl. F41H 9/10; G08B 25/01

(52) U.S. Cl. CPC F41H 9/10; G08B 25/016

(57) ABSTRACT

A multi-functional self-defense device comprises primarily a main body, a tube body embedded in the main body, and a bottle body sheathed in the tube body. At a top edge of the main body is disposed a positioning groove. At a bottom edge of the tube body is disposed a sliding block. With the sliding block and the positioning groove the tube body and the main body are embedded in or disengaged from each other. In an interior of the main body is disposed a control circuit comprising a microcontroller, alarm module, voice recognition module, emitting module, and GPS module, and buttons connected to the control circuit. An interior of the bottle body is provided for holding chemical agent and high pressure gas. When under attack a user may press the button on the main body or shout a specific word to activate the alarm, notify rescue units such as a police station, and inform them of the user's location. In an emergency a user may press the button on the tube body and cause the chemical agent to break through a top portion of the self-defense device so that the user may speedily escape from the scene.

### BACKGROUND OF THE INVENTION

### 1. Field of the Invention

The present invention relates to a multi-functional self-defense device, and particularly to a multi-functional self-defense device which may provide the functions of deterring and repelling assailants and of notification when a user is under attack and which may spray chemical agent in an emergency to facilitate the user's speedy escape from the scene.

### 2. Description of Related Art

As rapid changes and economic developments in our society have caused the crime rate to rise, there is growing concern over the personal safety of women who stay out late or who walk on deserted streets. Some women would purchase a self-defense sprayer to deter and repel assailants when under attack. However, when using a conventional self-defense sprayer, one has to aim the sprayer precisely at the assailant and press the nozzle head to spray chemical agent over the assailant. Therefore, in an emergency when it is difficult to aim at the target, a conventional self-defense sprayer may not be able to provide desired functions. Further, a conventional self-defense sprayer may only discharge chemical agent and may not achieve the functions of reporting to the police and positioning, which may delay real-time rescue. In view of this, after laborious research and experiments, the applicant has devised a multi-functional self-defense device which may provide the functions of deterring and repelling assailants and which may spray chemical agent in an emergency to facilitate the user's speedy escape from the scene.

### SUMMARY OF THE INVENTION

It is a primary purpose of the present invention to provide a multi-functional self-defense device which may provide the functions of deterring and repelling assailants and of notification when a user is under attack and which may spray chemical agent in an emergency to facilitate the user's speedy escape from the scene.

A foregoing multi-functional self-defense device comprises a main body, a tube body embedded in the main body, and a bottle body sheathed in the tube body. At a top edge of the main body is disposed a positioning groove. At a bottom edge of the tube body is disposed a sliding block. With the sliding block and the positioning groove the tube body and the main body are embedded in or disengaged from each other. In an interior of the main body is disposed a control circuit comprising a microcontroller, alarm module, voice recognition module, emitting module, and GPS module, and buttons connected to the control circuit. An interior of the bottle body is provided for holding chemical agent and high pressure gas. When under attack a user may press the button on the main body or shout a specific word to activate the alarm, notify rescue units such as a police station, and inform them of the user's location. In an emergency a user may press the button on the bottle body and cause the chemical agent to break through a top portion of the self-defense device so that the user may speedily escape from the scene.

A foregoing multi-functional self-defense device wherein on the tube body is disposed a button with a stopper clasped thereon. When the self-defense device is not used, the stopper obstructs the button and stops it from being pressed accidentally.

### BRIEF DESCRIPTION OF THE DRAWINGS

FIG. 1 is a three-dimensional view of the present invention;

FIG. 2 is a three-dimensional exploded view of the present invention;

FIG. 3 is a block diagram of a control circuit of the present invention;

FIG. 4 is a cut-away view of the tube body and main body embedded in each other according to the present invention;

FIG. 5 is a view of the present invention in use;

FIG. 6 and FIG. 7 are views of the present invention in separate use.

### DETAILED DESCRIPTION OF THE PREFERRED EMBODIMENTS

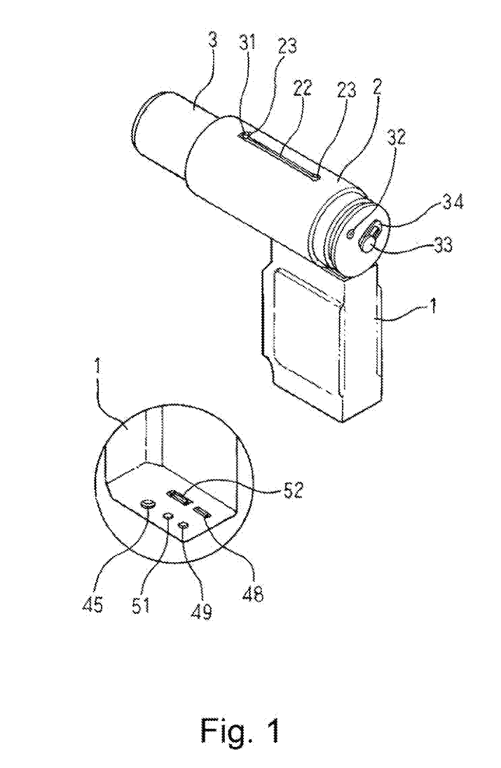

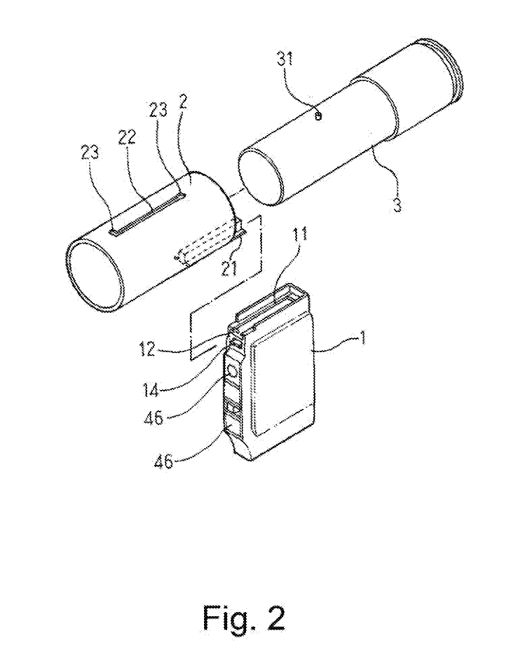

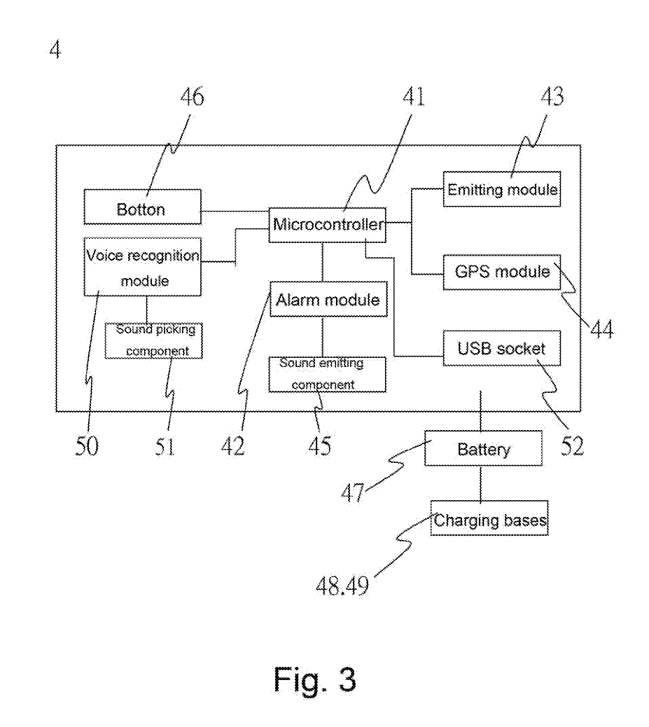

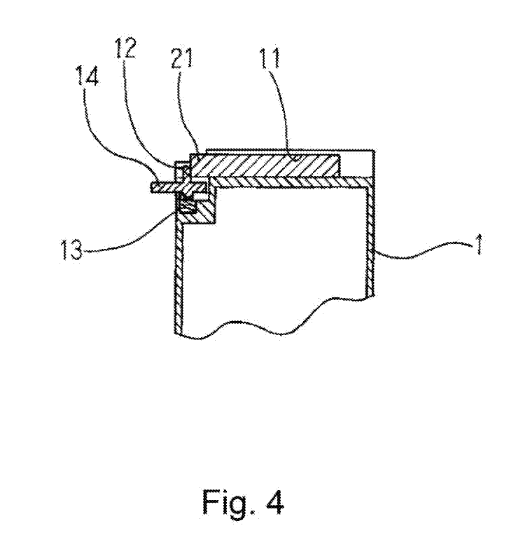

Please refer both to FIG. 1 and FIG. 2, along with FIG. 3 and FIG. 4, showing respectively a three-dimensional view and a three-dimensional exploded view of the present invention, as well as a block diagram of a control circuit of the present invention and a cut-away view of the tube body and main body embedded in each other according to the present invention. As the figures show, the present invention comprises a main body 1 and a tube body 2 embedded in the main body 1, and a bottle body 3 sheathed in the tube body 2. At a top edge of the main body 1 is disposed a positioning groove 11 formed in a generally inverted T-shape. At a front edge of the positioning groove 11 is disposed a top withstanding shaft 12. Below the top withstanding shaft 12 is disposed a spring 13 and a press plate 14 that is connected to the top withstanding shaft 12 and protrudes from a front edge of the main body 1. At a bottom edge of the tube body 2 is disposed a sliding block 21 that corresponds to the positioning groove 11 and is formed in a generally inverted T-shape. The tube body 2 may be slid into the positioning groove 11 with the sliding block 21 and be embedded above the main body 1 with the top withstanding shaft 12 withstanding and positioning it. The press plate 14 may be pressed down to disengage the top withstanding shaft 12 from the sliding block 21 so that the tube body 2 may slide out of the positioning groove 11 and be disengaged from the main body 1.

In an interior of the main body 1 is disposed a control circuit 4 comprising a microcontroller 41, an alarm module 42, emitting module 43, GPS module 44 and sound emitting component 45 (a loudspeaker or buzzer) connected to the microcontroller 41, and a plurality of buttons 46 that are connected to the control circuit 4 and protrude from appropriate positions on the main body 1. A battery 47 provides the control circuit 4 with power source. The battery 47 may be rechargeable and is connected to charging bases 48 and 49 (USB or terminal sockets) at a bottom edge of the main body 1. Also connected to the control circuit 4 is a voice recognition module 50 that is connected to a sound picking component 51 (mini microphone) and a USB socket 52 for a memory card to be plugged therein.

A cut slot 22 is disposed at an upper edge of the tube body 2. On two ends of the cut slot 22 are respectively disposed positioning portions 23 that are wider.

At a top edge of the bottle body 3 is disposed a protruding pole 31. The protruding pole 31 is slid along the cut slot 22 at an upper edge of the tube body 2 and embedded in the positioning portion 23 so that the bottle body 3 is sheathed in the tube body 2. An interior of the bottle body 3 is provided for holding chemical agent and high pressure gas. At a back edge of the bottle body 3 is disposed an air hole 32 for injecting high pressure gas into the bottle body 3 and a button 33 for releasing high pressure gas. A stopper 34 is clasped on the button 33. When the self-defense device is not used, the stopper 34 obstructs the button 33 and stops it from being pressed accidentally. In the present embodiment, the chemical agent is an irritant such as self-defense spray, pepper spray, or tear gas.

The foregoing components are assembled to form a multi-functional self-defense device. When under attack, a user may remove the stopper 34 and spray the chemical agent from a front end of the bottle body 3 by pressing the button 33 to deter and repel the assailant. The user may also press the button 46 on the main body 1 or shout a specific word, which is recognized by the voice recognition module 50. The microcontroller 41 then drives the sound emitting component 45 to emit high decibel alarm sounds as a warning to attract the attention of people nearby, who may lend a helping hand in time. The microcontroller 41 may also drive the emitting module 43 to emit distress signals to recuse units such as a police station or family and friends (via communication network such as GSM). Further, a positioning search signal is transmitted via the GPS module 44 to generate positional information by the global positioning system so that rescue units may arrive at the scene in real time upon receiving the distress signals and the positional information of the GPS. In the event of disaster, illness, mountain accident or disorientation, the present invention may likewise be used to ask recuse units for help.

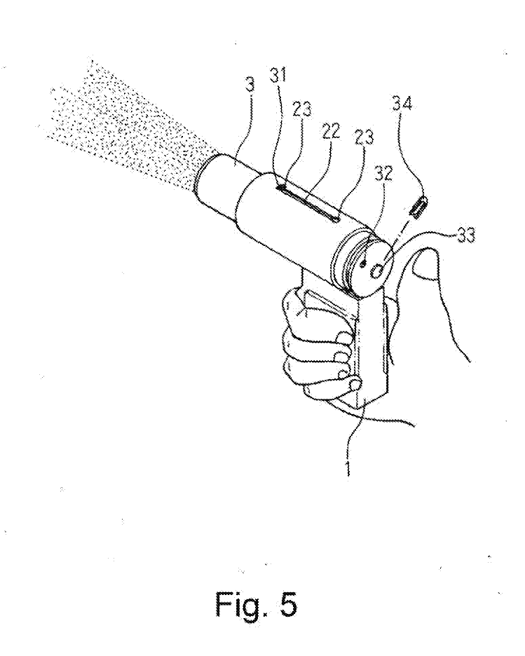

Please refer to FIG. 5, showing a view of the present invention in use. Please refer also to FIG. 2. As the figures show, when under attack a user holds the main body 1 of the present invention like holding a pistol grip, removes the stopper 34, and press the button 33 disposed on the bottle body 3 with one finger to spray the chemical agent from a front end of the bottle body 3 by releasing the high pressure gas to achieve the purpose of deterring and repelling the assailant.

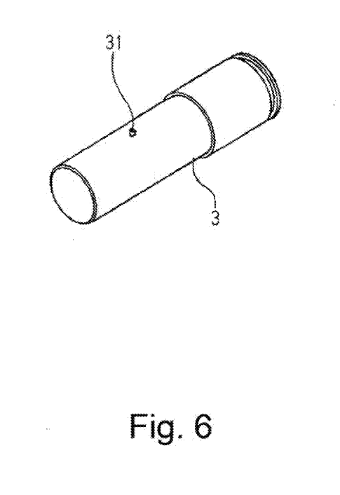

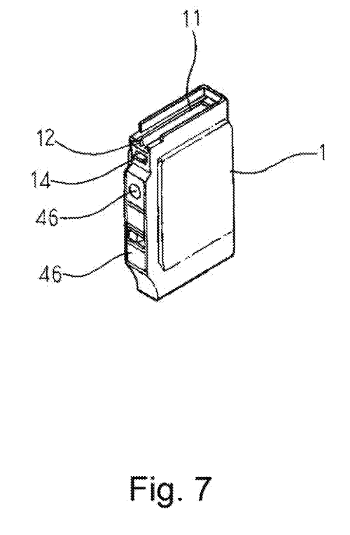

Please refer both to FIG. 6 and FIG. 7, showing views of the present invention in separate use. As the figures show, besides using the present invention as is shown in FIG. 5, a user may also slide the bottle body 3 out of the tube body 2 and carry the bottle body 3 alone. When under attack a user holds the bottle body 3, removes the stopper 34, and press the button 33 disposed on the bottle body 3 with one finger to spray the chemical agent from a front end of the bottle body 3 to achieve the purpose of deterring and repelling the assailant. The main body 1 may also be disengaged from the tube body 2 and carried alone. The user may press the button 46 or shout a specific word (a specific voice code set and stored in advance by the user), which is picked up by the sound picking component 51 and recognized by the voice recognition module 50. The microcontroller 41 then drives the sound emitting component 45 to emit high decibel alarm sounds and drives the emitting module 43 to emit distress signals to recuse units (transmitted to a police station or mobile phones of family and friends via communication network such as GSM). Further, positional information is generated by the GPS module 44 so that rescue units may arrive at the scene in real time with the help of the distress signals and the positional information of the GPS.

The foregoing preferred embodiments of the present invention are illustrated of the present invention rather than limiting of the present invention. It is intended to cover various modifications and changes included within the spirit and scope of the appended claims, the scope of which should be accorded the broadest interpretation so as to encompass all such modifications and similar structures.

In view of the foregoing, the present invention relates to a multi-functional self-defense device comprising a bottle body with a nozzle head disposed thereon and chemical agent held therein, and a main body equipped with a control circuit. When a user is under attack, the present invention may provide the functions of deterring and repelling assailants and of notification. In an emergency the present invention may also spray chemical agent to facilitate the user's speedy escape from the scene.

What is claimed is:

1. A multi-functional self-defense device, comprising:
a main body, at a top edge thereof is disposed a positioning groove formed in a generally inverted T-shape and in an interior thereof is disposed a control circuit comprising a microcontroller and an alarm module, emitting module, GPS module and sound emitting component connected to the microcontroller, wherein the control circuit is connected to a button protruding from the main body for activating the alarm module, emitting module, and GPS module when being pressed;
a tube body, at a bottom edge thereof is disposed a sliding block that corresponds to the positioning groove and is formed in a generally inverted T-shape, wherein the tube body may be slid into the positioning groove with the sliding block and be embedded above the main body; and
a bottle body sheathed in the tube body, wherein an interior thereof is provided for holding chemical agent under high pressure and high pressure gas and at a back edge thereof is disposed a button;
when under attack a user may press the button on the bottle body and spray the chemical agent from a front end of the bottle body to deter and repel the assailant, and may press the button on the main body to activate the alarm, notify rescue units such as a police station, and inform them of the user's location.

2. A multi-functional self-defense device of claim 1, wherein at a front edge of the positioning groove is disposed a top withstanding shaft with a spring disposed therebelow and a press plate that is connected to the top withstanding shaft and protrudes from a front edge of the main body, so that the tube body may be slid into the positioning groove with the sliding block and be embedded above the main body with the top withstanding shaft withstanding and positioning it.

3. A multi-functional self-defense device of claim 1, wherein a cut slot is disposed at an upper edge of the tube body, on two ends of the cut slot are respectively disposed positioning portions that are wider, and at a top edge of the bottle body is disposed a protruding pole, so that the protruding pole is slid along the cut slot at an upper edge of the tube body and embedded in the positioning portion to sheath the bottle body in the tube body.

4. A multi-functional self-defense device of claim 1, wherein the sound emitting component is a loudspeaker or buzzer.

5. A multi-functional self-defense device of claim 1, wherein the control circuit in the main body is further connected to a voice recognition module for activating the alarm module, emitting module, and GPS module.
